(19) United States
(12) Patent Application Publication
(10) Pub. No.: US 2026/0169938 A1
(43) Pub. Date: Jun. 18, 2026

(54) ATOMIC COMPUTE REBINDING ENGINE (ACRE)

(71) Applicant: Intel Corporation, Santa Clara, CA (US)

(72) Inventors: Ashwani KUMAR, Bangalore (IN); Hemanthkumar SIVARAJ, Bengaluru (IN); Trupti JOSHI, Bengaluru (IN); Amruta MISRA, Bangalore (IN)

(21) Appl. No.: 19/533,801

(22) Filed: Feb. 9, 2026

(51) Int. Cl. G06F 13/28

(52) U.S. Cl. CPC G06F 13/28; G06F 2213/28

(57) ABSTRACT

Apparatus and methods for an Atomic Compute Rebinding Engine (ACRE). ACRE facilitates atomic migration of threads across compute/processing elements, including heterogeneous compute/processing elements. ACRE captures a snapshot of an architecture state of a thread executing a source compute/processing element such as a compute core with a capture engine and sends a migration packet containing the snapshot over a fabric to a compute/processing element in a target such as a target core or pipeline. A restore engine is then used to atomically restore registers for the compute/processing element with the register states in the snapshot. The migrated thread then resumes execution in the target pipeline. ACRE may be used to facilitate thread migration across compute/processing elements within an Infrastructure Processing Unit (IPU), Smart Network Interface Controller (SmartNIC), or Data Processing Unit (DPU), and between compute/processing elements on an IPU, SmartNIC, or DPU and CPUs and XPUs such as GPUs and FPGAs.

### BACKGROUND INFORMATION

Modern Network Function Virtualization (NFV) chains, packet-processing pipelines, and latency-sensitive microservices require moving running compute contexts (threads) between Central Processing Unit (CPU) cores, Infrastructure Processing Unit (IPU) pipelines, or accelerators such as Graphics Processing Unit (GPUs), Network Processing Units and Field Programmable Gate Arrays (FPGA) s without missing hard deadlines (sub-ms, often<100 μs) and without disrupting sibling work or device Direct Memory Access (DMA) ordering. Current approaches such as Operating System Inter-Processor Interrupts (OS IPIs), C-state save/restore, and driver-based rebinds incur tens of microseconds-to-milliseconds and introduce jitter, packet loss, and/or migration lane pipeline stalls.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a high-level block diagram of ACRE, according to one embodiment.

FIG. 2 is a schematic diagram of an exemplary IPU chip, according to one embodiment;

FIG. 2a shows an augmented version of FIG. 2 illustrating further details of the packet processing pipeline and the lookaside cryptographic and compression engine, according to one embodiment

FIG. 3 is a schematic diagram illustrating further details of a per-port ACRE client, according to one embodiment;

FIG. 4 is a schematic diagram depicting functional blocks and interfaces of a central auth Acre engine/control cluster, according to one embodiment;

FIG. 5 is a schematic diagram depicting functional blocks and interfaces for a Migration DMA Engine (MDE) & Migration Lane (ML) datapath, according to one embodiment;

FIG. 6 is a is a schematic diagram depicting interfaces for the Auth Key Store/HSM area, according to one embodiment;

FIG. 7 is a flowchart illustrating operations performed during an atomic thread migration, according to one embodiment;

FIG. 8 is a flowchart illustrating operations performed during in-IPU micro-flow for a fast in-place remap (no page-copy), according to one embodiment;

FIG. 9 is a micro-level sequence diagram corresponding to the in-IPU micro-flow of FIG. 8, according to one embodiment;

FIG. 10 is a micro-level sequence diagram for a PAGE-COPY PATH process, according to one embodiment;

FIG. 11 is a schematic diagram of an IPU PCIe card, according to one embodiment;

FIG. 11a shows an augmented version of the IPU PCIe card of FIG. 11 showing further details of the packet processing pipeline and lookaside cryptographic and compression engine illustrated in FIG. 2a; and

FIG. 11b shows a variant of an IPU PCIe card including an XPU and an FPGA, according to one embodiment; and

### DETAILED DESCRIPTION

Embodiments of methods and apparatus for an Atomic Compute Rebinding Engine (ACRE) are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

As used herein, the terminology “XPU” is used to refer to Other Processing Unit, meaning other than a Central Processing Unit (CPU). XPUs include Graphic Processing Units (GPUs) or General Purpose GPUs (GP-GPUs), Network Processing Units (NPUs), Tensor Processing Units (TPUs), Data Processing Units (DPUs), Infrastructure Processing Units (IPUs), Artificial Intelligence (AI) processors or AI inference units and/or other accelerators, FPGAs (Field Programmable Gate Arrays) and/or other programmable logic (used for compute purposes), etc.

In accordance with aspects of the embodiments disclosed herein, a solution comprising a fabric-native hardware primitive in an apparatus including a Smart Network Interface Controller (SmartNIC) or an Infrastructure Processing Unit (IPU) is provided that can atomically capture a thread's full execution context, stream it across the fabric, and restore it into a target such as a target core or target XPU pipeline in sub-microsecond time, while guaranteeing correctness (e.g., no double-run, preserved packet order) and minimal disruption to other threads. The solution, referred to as an Atomic Compute Rebinding Engine (ACRE), is a SmartNIC/IPU-resident hardware engine and protocol that turns thread migration into a first-class fabric primitive. Instead of the operating system (OS) performing heavy, serialized state transfers, ACRE:
Provides per-slot (per reserved thread slot in a target XPU) hardware quiesce and restore primitives;
Captures a thread's architectural state in a small, banked local buffer (ACRE Buffer) on the IPU/Smart NIC or on source core;
Streams the snapshot as a prioritized Migration Packet over the fabric to the target (CPU core, XPU pipeline, or IPU worker);
Target ACRE atomically restores registers, issues targeted cache/TLB coordination hints and resumes execution; and
Source slot is released only after confirmation—enforcing atomicity.

ACRE provides sub-μs end-to-end, per-thread granularity, fabric-prioritized messages, heterogeneous target support, is device-transparent (no device reset), and provides backward-compatible fallback to software. Further features include Fabric-native, atomic compute mobility—migration is a prioritized fabric operation (not an OS thread of work). ACRE provides per-thread (not per-core) low-latency capture/restore, which is different from core power states and from software saves.

ACRE provides heterogeneous target semantics, including supports for thread migrations such as CPU core ↔IPU pipeline ↔GPU/NPU (via cooperating XPU agents). ACRE provides atomic resume semantics plus device ordering guarantees. This eliminates windows where thread state is ambiguous. This combination of location (Smart NIC/IPU fabric) plus function (atomic per-thread migration) is novel and provides substantial improvement over current thread migration schemes.

Generally, ACRE functionality may be implemented on existing and new apparatus by adding new ACRE components. In one embodiment, the following new ACRE components are used.

On the source side (meaning where the thread to be migrated originates), an ACRE capture engine is used to capture an architecture state of thread. The capture engine may be on a CPU core, SmartNIC, or IPU that has visibility of the thread. The ACRE capture engine may also be implemented as a centralized component.

The captured architecture state is stored in an ACRE buffer, which is a small, banked SRAM (e.g., 2 KB) storing full architectural state snapshot.

Fabric Injection & Priority Tagging: integration with IPU fabric (CXL/UPI/IDI or on-chip NoC) to mark MigrationPackets as top-priority.

On the target side an ACRE restore engine is used. The ACRE restore engine may be co-located in a SmartNIC or IPU pipeline or may be implemented via an XPU fabric agent that owns a reserved execution slot. In one embodiment, an ACRE restore engine is implemented as a per-port ACRE client, as described and illustrated below.

Control Plane: ACRE_CTRL MMIO/privileged MSR for triggering migrations; ACRE_STATUS for completion.

Under an optional integration, ACRE may be integrated with a Fabric Memory Mobility Engine (fMME) to coordinate page movement if data locality must move with compute.

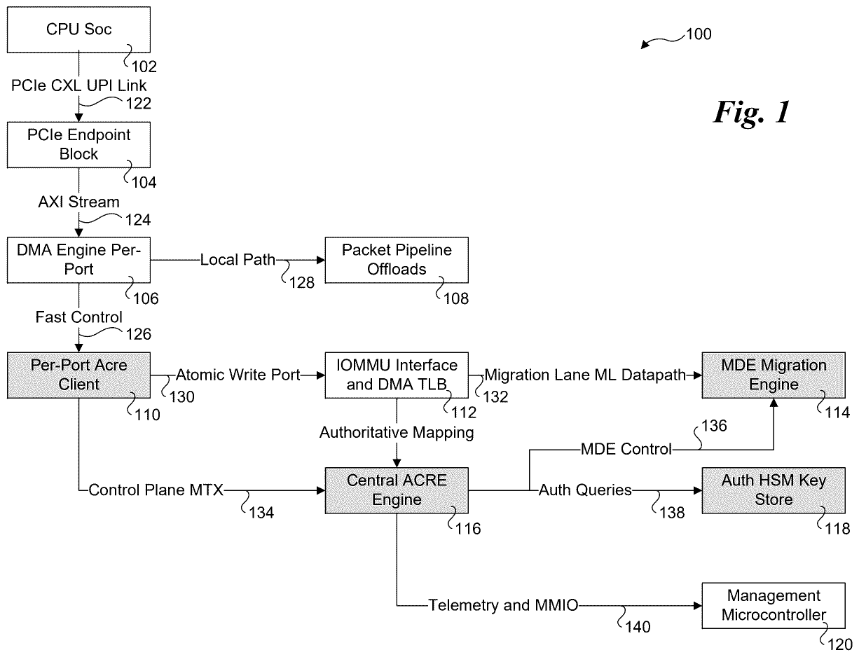

FIG. 1 shows a high-level block diagram 100 of ACRE, according to one embodiment. In diagram 100, the blocks with a white background are existing blocks, while the blocks with a gray background are new. The existing block level components include a CPU System on a Chip (SoC) 102, a Peripheral Component Interconnect Express (PCIe) endpoint block 104, a Direct Memory Access (DMA) engine per-port block 106, a packet pipeline offloads block 108, an IOMMU (Input-Output Memory Management Unit) interface and DMA TLB (Translation Look-aside Buffer) 112, and a management microcontroller 120. The new ACRE blocks include a per-port ACRE client 110, an MDE (Migration DMA Engine) migration engine 114, a central ACRE engine 116, and an auth (authentication) HSM (Hardware Security Module) key store 118.

Diagram 100 further shows communication links and interfaces including a PCIe CXL (Compute Express Link) link 122, an AXI (Advanced extensible Interface) stream 124, a fast control path 126, a local path 128, an atomic write port interface 130, a migration lane (ML) datapath 132, a control plane MTX (migration transaction) interface 134, an MDE control interface 136, an auth queries interface 138, and a telemetry and MMIO (memory-mapped input-output) interface 140.

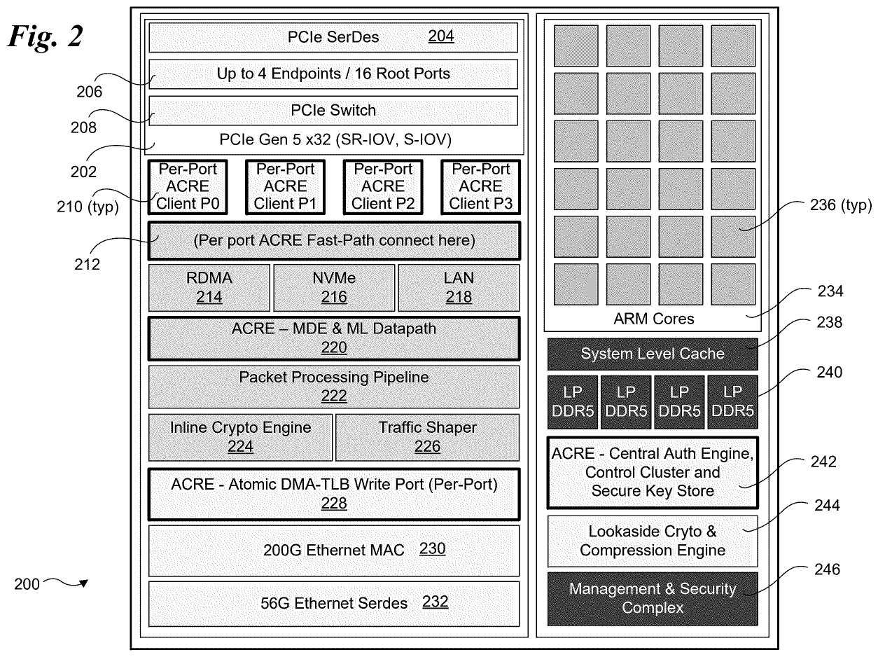

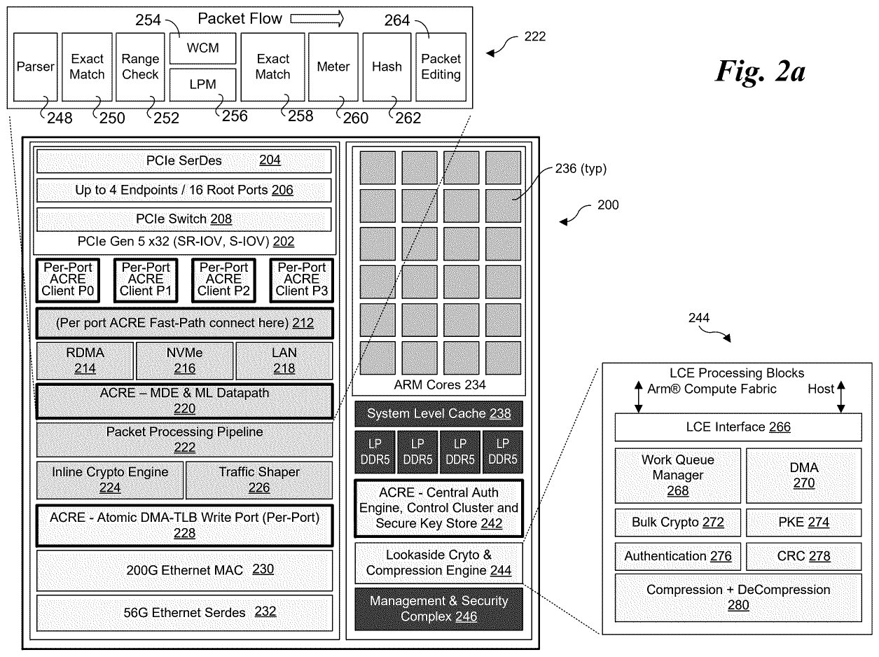

FIG. 2 shows an exemplary IPU chip 200 that may be installed on a main board of a compute platform or may be included on a daughterboard or an expansion card, such as but not limited to a PCIe card. In this diagram blocks/components with a thin outline correspond to existing components while blocks shown in bolded outline correspond to blocks used to implement ACRE functionality.

IPU chip 200 includes a PCIe interface 202 including a PCIe SerDes (Serializer/Deserializer) block 204, a PCI block 206 having up to 4 PCI endpoints and 16 PCIe root ports in the illustrated embodiment, and a PCIe switch 208. In the illustrated embodiment, PCIe interface 202 is a 5^{th} generation PCIe interface having 32 lanes and supports SR-IOV (Single Root-I/O Virtualization) and S-IOV (Scalable I/O Virtualization). SR-IOV and S-IOV are facilitated by Physical Functions (PFs) and Virtual Functions (VFs) that are implemented in accordance with SR-IOV and S-IOV specifications.

Next, IPU chip 200 includes a set of IP blocks, include per-port ACRE clients 210, a per-port ACRE fast path connect block 212, an RDMA (Remote Direct Memory Access) block 214, an NVMe (Non-volatile Memory Express) block 216, a LAN (Local Area Network) block 218, an ACRE Migration DMA Engine (MDE) & Migration Lane (ML) datapath 220, a packet processing pipeline 222, an inline cryptographic engine 224, and a traffic shaper 226.

IPU chip 200 includes various circuitry for implementing one or more Ethernet interfaces, including a 200 Gigabits/second (G) Ethernet MAC (Media Access Control) block 230 and a 56G Ethernet Serdes block 232. Generally, the MAC and Ethernet Serdes resources in 200G Ethernet MAC block 230 and 56G Ethernet Serdes block 232 may be split between multiple Ethernet ports, under which each Ethernet port will be configured to support a standard Ethernet bandwidth and associated Ethernet protocol. IPU chip 200 also includes an ACRE-Atomic DMA-TLB Write Port (per-port) 228.

As shown in the upper right corner, IPU chip 200 includes a compute complex 234 including multiple ARM cores 236 employing an ARM® architecture. The ARM cores are used for executing various software components and applications that may run on IPU chip 200. ARM cores 236 are coupled to a system level cache block 238 which is used to cache memory accessed from one or more memory devices that are coupled to IPU Chip 200 via one or more memory channels. In this non-limiting example, the memory devices are LP DDR5 memory devices, and the memory channels are depicted as LP DDR5 blocks 240. More generally, any existing or future memory standard may be used, including those described below.

IPU chip 200 includes an ACRE central authentication engine, an ACRE control cluster, and a secure key store. In FIG. 2 these blocks/components are collectively depicted in a block 242 for illustrative purposes and convenience. Details of each of these blocks and components are described and illustrated below.

The last two IP blocks for IPU chip 200 include a lookaside cryptographic and compression engine 244 and a management and security complex 246. Lookaside cryptographic and compression engine 244 supports cryptographic (encryption/description) and compression/decompression operations that are offloaded from ARM cores 236. Management and security complex 246 comprises logic for implementing various management and security functions and operations.

FIG. 2a shows further details of packet processing pipeline 222 and Lookaside cryptographic and compression engine 244, according to one embodiment. Packet processing pipeline 222 comprises a general-purpose packet processor employing a high-performance design with flexibility for current and future applications. It supports software programming and in one embodiment supports P4 (Programming Protocol-Independent Packet Processors)-based software for enhanced features. It also enables high-performance networking for virtual, microservice, and physical environments.

As shown in the top portion of FIG. 2a, packet processing pipeline 222 includes a parser 248, an exact match block 250, a range check block 252, a Wildcard Match (WCM) block 254, a Longest Prefix Match (LPM) block 256, an exact match block 258, a meter block 260, a hash block 262, and a packet editing block 264. These components and blocks may be configured to support custom packet processing pipelines.

Lookaside cryptographic and compression engine 244 includes LCE (Lookaside Crypto and Compression Engine) interfaces 266, which enable connectivity with the on-chip Arm® Compute Fabric and a host. The functional blocks include a work queue manager 268, a DMA block 270, a bulk cryptography block 272, a Public Key Encryption (PKE) block 274, an authentication block 276, a Cyclic Redundancy Check (CRC) block 278, and a compression+decompression block 280.

The host connectivity supports virtualization across multiple hosts with advanced QoS (Quality of Service) and scheduling. The LCE processing blocks support custom chaining of offloads to build custom hardware pipelines. In one embodiment the cryptography components support AES-{GCM,XTS, CTR, GMAC}, SHA {1,2,3}+ HMAC. In one embodiment, compression+decompression block 280 support Z-standard, Deflate, and Snappy compression.

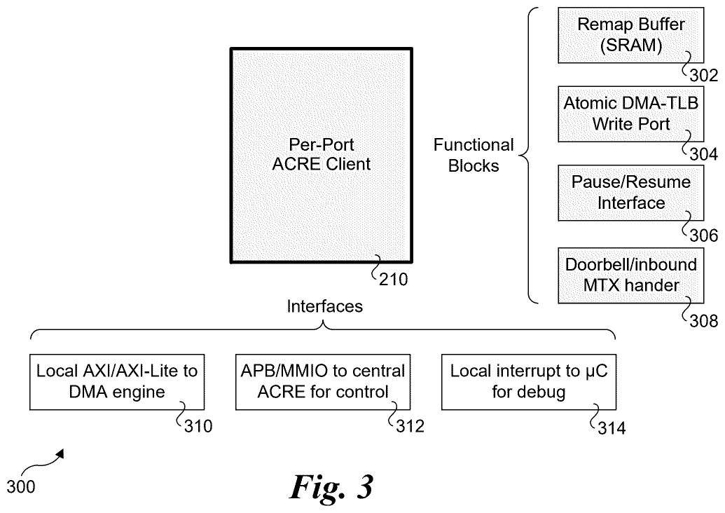

FIG. 3 shows a diagram 300 illustrating further details of a per-port ACRE client 210, including a set of functional blocks and interfaces, according to one embodiment. The blocks on the right are functional blocks and include a remap buffer (SRAM) 302, an atomic DMA-TLB write port 304, a pause/resume interface 306, and a doorbell/inbound MTX handler 308.

Remap Buffer (SRAM) 302 is a small buffer implemented in Synchronous Random Access Memory (SRAM) (e.g., 4-64 KB per VF/port depending on expected entries). Atomic DMA-TLB write port 304 is a write channel into DMA translation cache/TLB with multi-entry atomic commit semantics. Pause/Resume interface 306 employs a sideband signal path to NIC queue controller to quiesce/resume DMA. Doorbell/inbound MTX handler 308 receives MTX from central ACRE or fabric and forwards to central ACRE if needed.

The interfaces for per-port ACRE client 210 include a local AXI/AXI-Lite to DMA engine interface 310, an APB/MMIO to central ACRE interface for control 312, and a local interrupt to μC for debug interface 314.

In one embodiment the per-port ACRE client is located immediately adjacent to each port's DMA engine/PCIe endpoint block. This location minimizes PCIe/CXL roundtrip and device drain latency and enables atomic update close to where DMA translations are consumed.

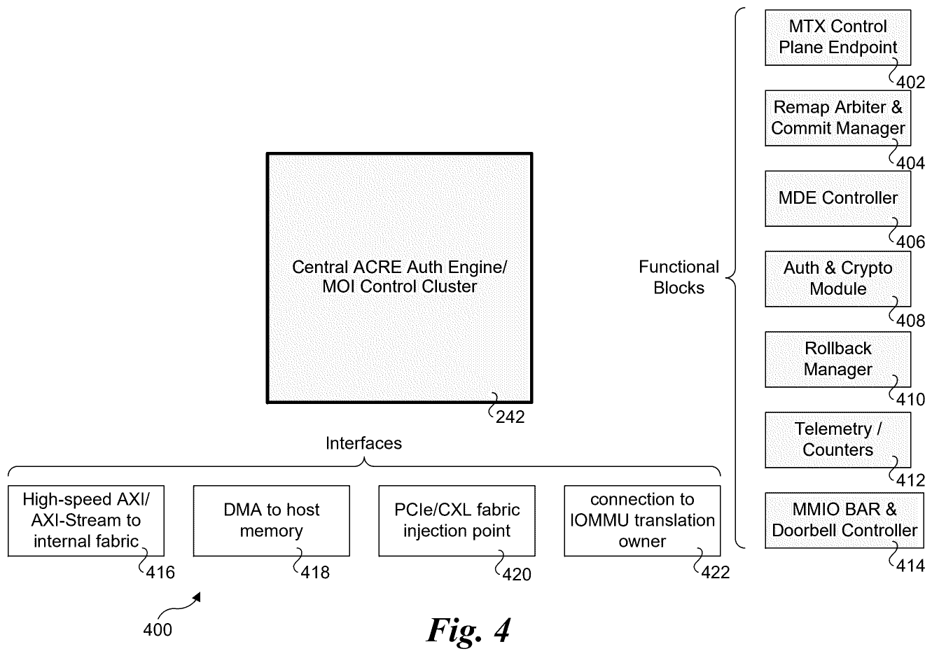

FIG. 4 shows a diagram 400 depicting functional blocks (to the right) and interfaces (below) of a central auth Acre engine/control cluster 242, according to one embodiment. MTX control plane endpoint 402 injects/receives MTX frames into MOI (Migration-Optimized Interconnect) (MTX control plane+ML data plane) fabric, priority handling, sequencing logic. Remap Arbiter & Commit Manager 404 orders remap transactions, reserves commit_version, and coordinates multi-port commits. MDE Controller 406 programs the MDE datapath, schedules ML flows (bandwidth reservation), and verifies checksums.

In one embodiment, Auth & Crypto Module 408 is an HMAC (Hash-based Message Authentication Code) verifier/signature checker. It validates owner tokens and signs commit acknowledgements. It can be used as an HSM or crypto accelerator. Rollback Manager 410 stores previous mapping snapshots/rollback tokens and issues rollback if commit fails. Telemetry/Counters 412 implement an IDRU_REMAP_COUNT, latency histograms, pause latency, and ML usage counters. MMIO BAR (Base Address Register) & Doorbell Controller 414 provides host-visible registers and doorbell and supports ACRE_TXN_DESC (transaction description) DMA reads. IDRU (I/O Device Re-mapping Unit) is a fabric-resident hardware engine integrated with the IOMMU/fabric that performs atomic, hardware-coordinated VF/PF DMA remaps by (1) issuing sub microsecond pause/resume control to a device, (2) performing an atomic DMA translation table swap in the IOMMU, and (3) resuming device DMA, all without device reset or driver reinitialization.

The interfaces for central auth ACRE Engine/control cluster 242 include a high-speed AXI/AXI-Stream to internal fabric interface 416, a DMA to host memory interface 418, a PCIe/CXL fabric injection point 420, and a connection to IOMMU translation owner interface 422.

In one embodiment, central auth Acre engine/control cluster 242 is located at the IPU control plane/control cluster, near the management microcontroller and switch fabric injection point. This location centralizes auth, global ordering, rollback, MDE scheduling and inter-port coordination.

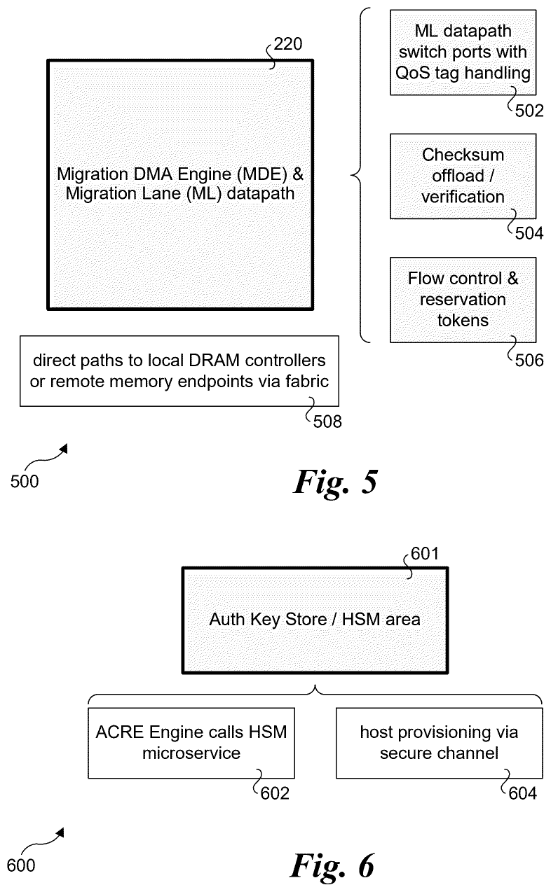

FIG. 5 shows a diagram 500 depicting functional blocks and interfaces for ACRE Migration DMA Engine (MDE) & Migration Lane (ML) datapath 220. The functional blocks include ML datapath switch ports with QoS tag handling 502, Checksum offload/verification 504, and flow control & reservation tokens 506. The interfaces 508 include direct paths to local DRAM controllers or remote memory endpoints via fabric.

In one embodiment, Migration MDE & ML datapath 220 comprise distributed dataplane engines inside the IPU fabric; MDE control in central auth ACRE, datapath elements on routing fabric. This provides low-latency, QoS-prioritized direct DRAM-to-DRAM bulk copy.

FIG. 6 shows a diagram 600 depicting interfaces for Auth Key Store/HSM area 601. The interfaces include an ACRE engine calls HSM microservice interface 602 and an interface 604 supporting host provisioning via a secure channel. In one embodiment, Auth Key Store/HSM area 601 is located in a secure partition in control cluster, such as within an IPU secure enclave or on-chip HSM, for example. This location provides low-latency owner_token verification in a secure manner.

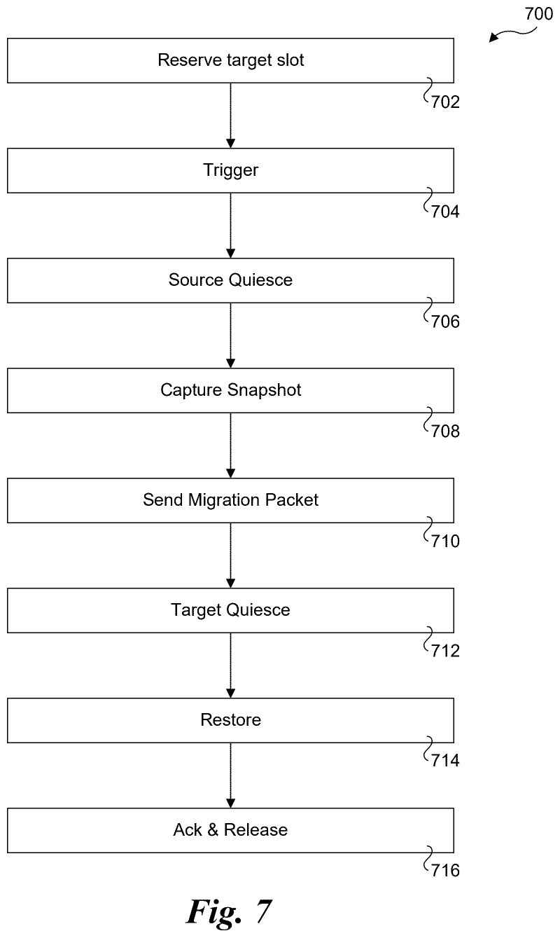

FIG. 7 shows a flowchart 700 illustrating operations performed during an atomic thread migration, according to one embodiment. In this example, assume a packet classifier thread T on CPU core A needs to move to IPU pipeline P2.

The process begins in a block 702 in which a target slot is reserved. For example, the operating system or hypervisor marks a target slot on P2 as reserved for thread T: vfio_acre_reserve(slot_id, T).

In a block 704 a trigger is effect where the host writes ACRE_CTRL={tid=T, target_slot=P2, flags}. The next operation is source quiesce, as depicted in a block 706. The source ACRE capture engine requests thread T to quiesce, which stalls, fetch, and drains micro-ops for thread T. Only thread T is quiesced, while other threads unaffected. The latency (time) for this operation is

$${t}_{q}^{s} .$$

In a block 708 a snapshot of the architecture state is capture. An ACRE capture engine writes registers/MSRs (Machine State Registers) into an ACRE Buffer in parallel (time t_{c}). In a block 710, a copy of the buffer is sent as a MigrationPacket prioritized on the fabric (time t_{f}).

Next, in a block 712 a target quiesce operation is performed. The target slot P2 ACRE engine quiesces its slot (if any), and readies for restore

$$( time {t}_{q}^{t} ) .$$

In a block 714 a restore operation is performed. The target writes the buffer (extracted from the MigrationPacket) into a register file and issues prefetch/TLB hints (time tr).

The atomic migration is completed in a block 716 with Ack (Acknowledgement) and Release operations. The target acknowledges it has completed its operations; the source releases its quiesce; and thread T resumes on P2.

### Timing Math Example (IPU-Adjacent Fabric, Times in Nanoseconds (Ns))

Let:

$${t}_{q}^{s} = 80 - 120 ns ( source / quiesce / drain ) \\ {t}_{c} = 20 ns ( parallel capture ) \\ {t}_{f} = 20 ns ( fabric transfer for 2 KB prioritized packet ) \\ {t}_{q}^{t} = 80 - 120 ns ( target quiesce {t}_{r} = 20 ns ( restore )$$

Total typical latency:

$${T}_{ACRE} = {t}_{q}^{s} + {t}_{c} + {t}_{f} + {t}_{q}^{t} + {t}_{r} = 250 - 330 ns .$$

Conservative worst case under contention: <1 μs. Example target: ≤500 ns in real deployments.

### Example: Moving Packet Classifier Thread—Numeric Impact

Assume a 100 Gbps NIC feeding a classifier thread T. If T is paused for T_{ACRE}=300 ns, bytes in flight:

$$B = 100 Gb / s \times 300 ns = 100 \times {10}^{9} / 8 \times 300 \times {10}^{- 9} \approx 3.75 KB$$

Compare to software rebind (5 ms)

$${B}_{SW} = 100 GB / s \times 5 ms \approx 62.5 MB \\ Reduction factor = 62.5 MB / 375 KB \approx 16 , 667 x .$$

### Example: Microservice Token Server (AI Inference)

Baseline: token dispatch thread migration (software)→10-50 μs latency spikes→P99 inflates dramatically.
With ACRE: migrations invisible (≤0.5 μs)→tail latencies controlled→QPS can be scaled up 20-40% without extra capacity.
   Integration with Heterogeneous Targets

For GPU/NPU restore, the ACRE Restore Engine negotiates with XPU runtime:
the MigrationPacket contains registers and minimal context; the XPU runtime restores lightweight state into its worker thread; additional device state (e.g., DMA pointers) can be remapped via IDRU/fMME primitives concurrently. The fabric coordinates atomicity across compute+memory mapping.

### Correctness & Cache/TLB Handling

Per-thread cache tagging (optional): L1 lines optionally tagged with ThreadID so writes can be selectively flushed; otherwise L1 writebacks happen at capture.
TLB cooperation: Target issues a targeted TLB prefill/invalidation for the thread's address space entries (if PTE movement required, coordinate with fMME).
Atomicity: source is released only after target ACK; no two instances run simultaneously.

### Micro-Level Sequence Examples

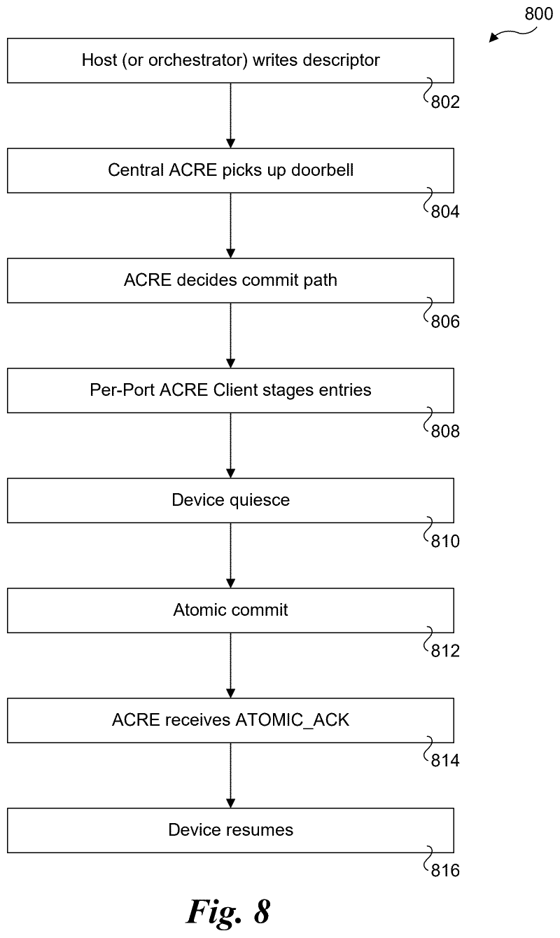

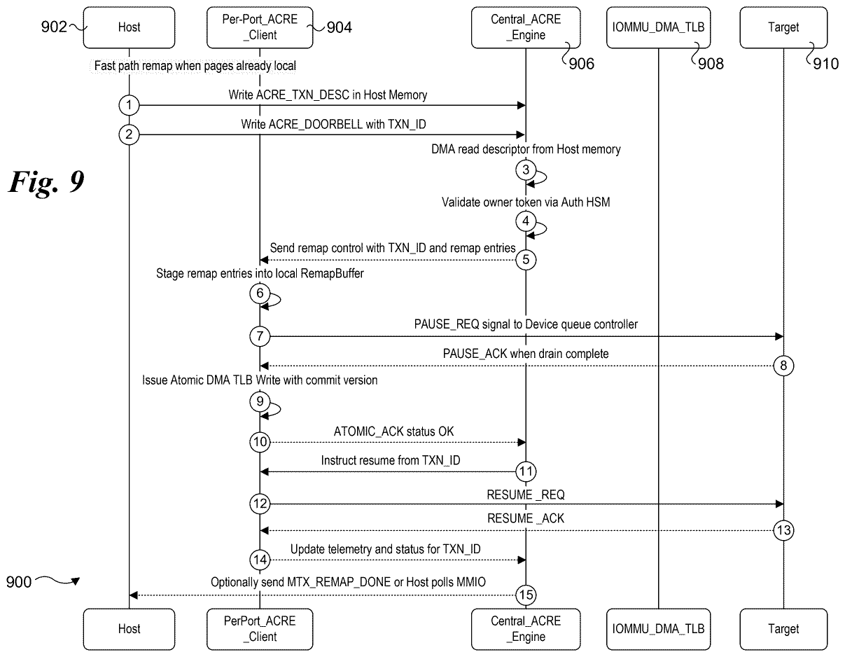

FIG. 8 shows a flowchart 800 illustrating operations performed during in-IPU micro-flow for a fast in-place remap (no page-copy), according to one embodiment. The corresponding signals and dataflows are shown in a micro-level sequence diagram 900 in FIG. 9. The components/blocks shown at the top of diagram 900 include a host 902, a per-port_Acre_Client 904, Central_ACRE_Engine 906, IOMMU_DMA_TLB 908, and a target 910. The signals and/or dataflow operations in diagram 900 are depicted using encircled numbers.

As shown toward the top of diagram 900, past path remap is used when pages are already local.

The process begins in block 802 of flowchart 800 in which a host (or orchestrator) writes a descriptor where the host (or orchestrator) writes ACRE_TXN_DESC (host memory) and rings ACRE_DOORBELL in the IPU BAR. This is signalled by PCIe write to BAR->doorbell IRQ to IPU μC (immediate). This is depicted in diagram 900 as signals ‘1’ and ‘2’ that are sent from host 902 to Central_ACRE_Engine 906 containing an ACRE transaction descriptor (ACRE_TXN_DESC) to be written to host memory followed by host 902 sending a signal instructing Central_ACRE Engine 906 to write an ACRE_DOORBELL with a transaction identified (TXN_ID).

Next, as depicted in block 804 of flowchart 800, the central ACRE engine picks up the doorbell. The central ACRE engine DMA-reads the ACRE_TXN_DESC (descriptor) via AXI master into an ACRE local prefetch buffer. The central ACRE engine then performs checks including validating an owner_token via HSM, and checks flags. This is shown in respective operations ‘3’ and ‘4’ in diagram 900 where Central_ACRE Engine 906 reads the DMA descriptor from host memory and validates the owner token via Auth HSM. In one embodiment the latency target for the descriptor fetch+auth is ˜100-300 ns (nanoseconds).

As shown in block 806 of flowchart 800, ACRE decides a commit path. If authoritative translation is local to a port, ACRE forwards commit to the Per-Port ACRE Client over internal AXI-Stream (fast path). If multi-port/multi-socket, ACRE programs a fabric MTX atomic commit with commit version and coordinates cross-node commits. The signaling is an internal MTX message injection. This is depicted in diagram 900 with Central_ACRE_Engine 906 sending a signal (‘5’) containing a remap control with TXN_ID and remap entries to Per-Port_ACRE_Client 904.

As depicted in block 808 of flowchart 800 and operation ‘6’ in diagram 900, Per-Port_ACRE_Client 904 then stages remap entries by writing RemapEntry[ ] into a local RemapBuffer (SRAM). In one embodiment, old entries are kept as a snapshot. The signal employs local SRAM writes and update of a local status register.

Next is device quiesce, as depicted in block 810 of flowchart 800. ACRE/Per-Port ACRE client toggles PAUSE_REQ to target 910 queue controller using a direct hardwired sideband signal or via a control packet. The target 910 then drains descriptors and asserts PAUSE_ACK via a local register/doorbell. This is depicted via signals ‘7’ and ‘8’ in diagram 900. As shown, Port_ACRE Client 904 sends a PAUSE_REQ (pause request) signal to the device queue controller, with target 910 returning a PAUSE_ACK (pause acknowledgment) when the drain is complete.

In a block 812 an atomic commit is performed. The Per-Port ACRE client writes into an Atomic DMA-TLB Write Port a block commit header (numEntries, commit_version, checksum) and RemapEntry[ ]. The Atomic write port performs an all-or-nothing update in the DMA translation cache/TLB, whereby the hardware ensures atomicity. The signal includes an atomic write bus transaction with a commit_event posted on completion. The atomic commit is depicted in diagram as a signal ‘9’ with Per-Port_ACRE_Client 904 issuing an atomic DMA TLB Write with commit version.

In block 814, ACRE receives an ATOMIC_ACK. Central ACRE/Per-port ACRE client verifies Atomic_ACK; if OK, sends RESUME_REQ to NIC queue controller. If ACK FAIL, ACRE issues rollback: writes old entries back via atomic write or commands rollback via fabric. These signals and operations are depicted in diagram 900 where Per-Port ACRE_Client 904 sends an ATOMIC_ACK status OK message to Central_ACRE Engine 906 (signal ‘10’), which returns a message containing an instruct resume from the TXN_ID (signal ‘11’).

The process is completed in block 816, where the resumes. The target resumes using new mapping; ACRE updates IDRU_STATS and signals host (MMIO or MTX_REMAP_DONE). For telemetry, latency history is updated. This is depicted in diagram 900 with Per-Port_ACRE_Client 904 sending a RESUME_REQ signal (‘12’) to target 910 which responds with a RESUME_ACK signal (‘13’) that is returned to Per-Port ACRE_Client 904. As depicted by operation ‘14’, Per-Port_ACRE_Client 904 sends a signal to Central_ACRE_Engine 906 to update telemetry and status for TXN_ID. In an optional operation, Central_ACRE_Engine 906 sends an MTX_REMAP_DONE signal (‘15’) to host 902 or the host polls the MMIO.

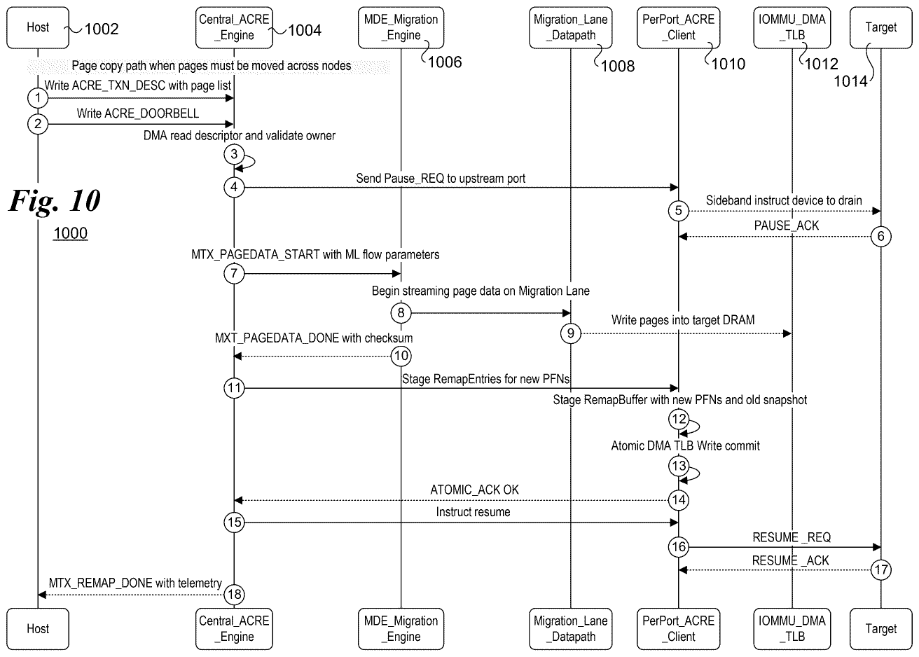

FIG. 10 shows a micro-level sequence diagram 1000 for a PAGE-COPY PATH process. The components/blocks shown at the top of sequence diagram 1000 include a host 1002, Central_ACRE_Engine 1004, MDE_Migration_Engine 1006, Migration_Lane_Datapath 1008, per-port_Acre_Client 1010, IOMMU_DMA_TLB 1012, and a target 1014.

The process begins with the host (or orchestrator) writing a descriptor ACRE_TXN_DESC (host memory) with a page list and rings ACRE_DOORBELL in the IPU BAR. This is signalled by PCIe write to BAR->doorbell IRQ to IPU uC (immediate). This is depicted in sequence diagram 1000 with host 1002 sending signals ‘1’ and ‘2’ to Central_ACRE Engine 1004 to write an ACRE_TXN_DESC with page list and write an ACRE_DOORBELL.

The central ACRE engine DMA-reads the acre_txn_desc_t (descriptor) via AXI master into an ACRE local prefetch buffer. The central ACRE engine then performs checks including validating an owner_token via HSM, and checks flags. This is shown in sequence diagram 1000 with operation ‘3’ where Central_ACRE Engine 1004 reads the DMA descriptor from host memory and validates the owner token.

Next, Central_ACRE_Engine 1004 sends a Pause_REQ signal (‘4’) to pause an upstream to per-port_Acre_Client 1010. Per-port_Acre_Client 1010 then sends a sideband signal to target 1014 to drain, with target 1014 returning a PAUSE_ACK confirming the drain has been completed, as depicted by signals ‘5’ and ‘6’.

As depicted by signal ‘7’, Central_ACRE_Engine 1004 sends an MTX PAGEDATA START with ML flow parameters signal to MDE_Migration_Engine 1006. In response MDE_Migration_Engine 1006 begins streaming page data on a Migration Lane to Migration_Lane_Datapath 1008 (signal/data ‘8’), with Migration_Lane_Datapath 1008 writing pages into the target DRAM via IOMMU_DMA_TLB 1012 (signal/data ‘9’).

At ‘10’, MDE_Migration_Engine 1006 returns an MXT_PAGEDATA DONE with checksum signal to Central_ACRE_Engine 1004. At ‘11’, Central_ACRE_Engine 1004 stages RemapEntries for new PFNs by sending a corresponds signal to per-port_Acre_Client 1010. Per-port_Acre_Client 1010 then stages RemapBuffer with new PNFs and old snapshot (operation ‘12’) and performs an Atomic DMA TLB Write commit (operation ‘13’). Per-port_Acre_Client 1010 the sends an ATOMIC_ACK OK signal′14′ to Central_ACRE Engine 1004.

The target then resumes. This is implemented with Central_ACRE Engine 1004 sending a Instruct resume signal 15 to per-port_Acre_Client 1010. per-port_Acre_Client 1010 then sends a RESUME_REQ signal 16 to target 1014, which returns a RESUME_ACK signal 17 to per-port_Acre_Client 1010. Asynchronously, Central_ACRE_Engine 1004 sends an MTX_REMAP_DONE with telemetry signal ‘18’ to host 1002.

### Exemplary Apparatus and Systems

Generally, aspects of the embodiments described and illustrated herein may be implemented in various types of apparatus and systems, such as but not limited to IPU, DPU, and SmartNIC cards and boards, IPU, DPU, and SmartNIC chips, packages, and the like. As will be recognized by those skilled in the art, IPUs, DPUs, and SmartNICs may refer to cards and boards including IPU, DPU, and SmartNIC chips or packages, or may refer to the IPU, DPU, and SmartNIC chip or package itself.

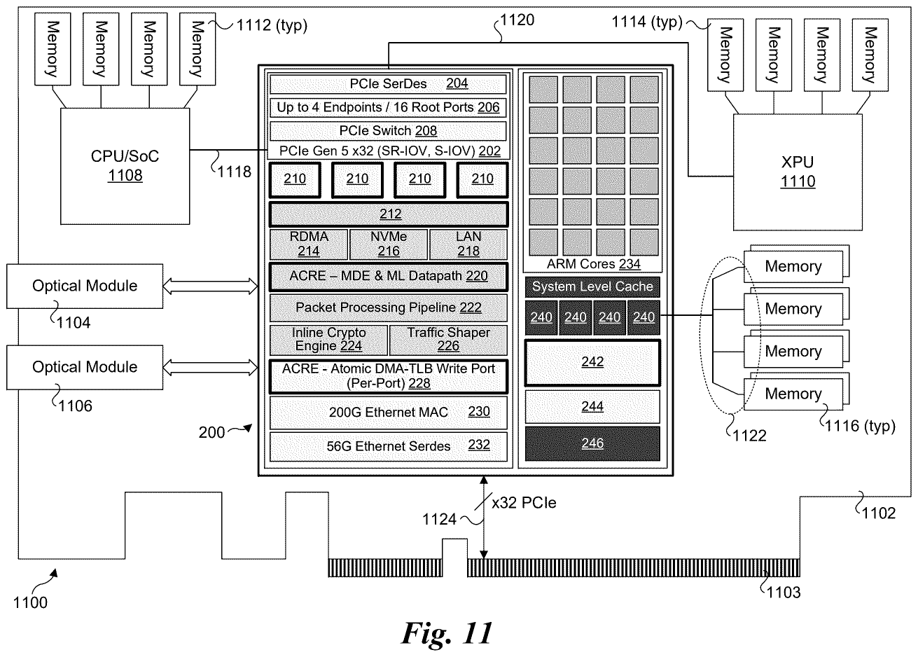

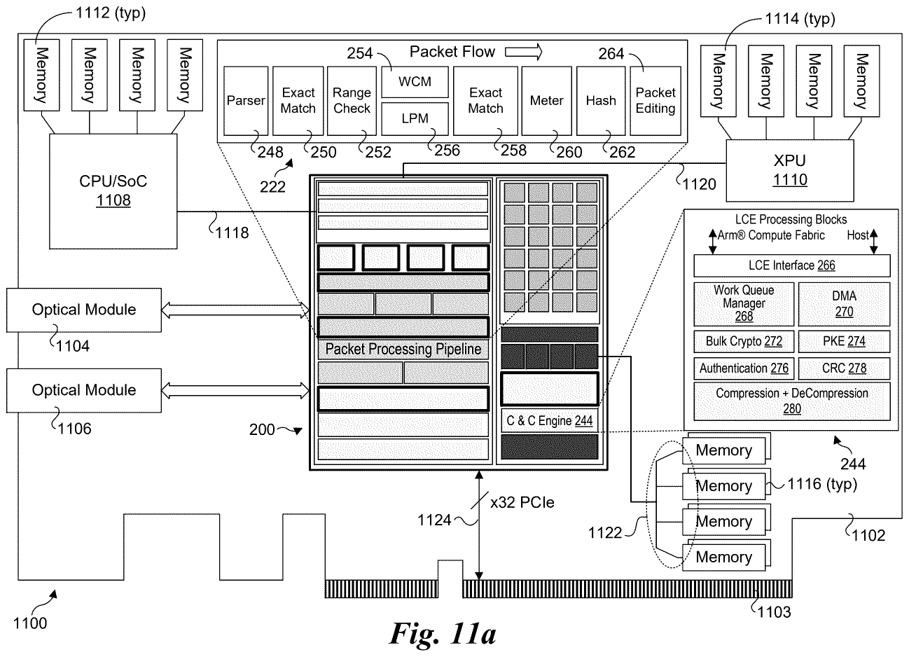

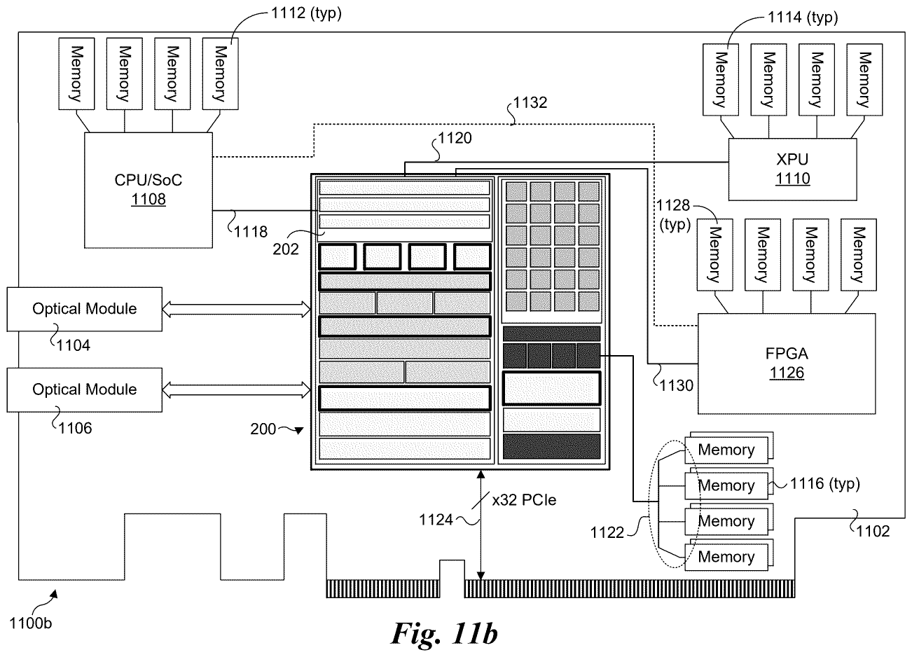

FIG. 11 shows an IPU 1100 comprising a PCIe card including a circuit board 1102 having a PCIe edge connector 1103 and to which various integrated circuit (IC) chips and components are mounted. The IC chips include an IPU chip 200 as described and illustrated above that is coupled to a pair of optical modules 1104 and 1106. The optical modules support communication with external components and systems over optical links, such as but not limited to 100 Gb optical links. Additional IC chips include a CPU/SoC (System on a Chip) 1108, an XPU 1110, and addition components include memory devices 1112, 1114, and 1116.

CPU/SoC 1108 is communicatively coupled to IPU chip 200 via a fabric link 1118 that is coupled between a PCIe port on the CPU/SoC and one of the ports for PCIe interface 202. Similarly, XPU 1110 is communicatively coupled to IPU chip 200 via a fabric link 1120 that is coupled between a PCIe port on the XPU to another one of the ports for PCIe interface 202.

The memory devices 1112, 1114, and 1116 are representative of memory that would be accessible to each of CPU/SoC 1108, XPU 1110, and IPU chip 200. Generally, CPU/SoC 1108 and XPU 1110 would have applicable memory interfaces to access their respective memory devices (e.g., memory modules and/or memory chips), with both the collective memory size, number of memory devices, and type of memory being appropriate for CPU/SoC 1108 and XPU 1110.

Generally, memory devices 1112, 1114, and 1116 may be volatile memory devices or NVRAM (non-volatile Random Access Memory) devices. In addition to the memory devices shown in the Figures herein, an apparatus or platform may include one or more storage devices that are not shown. Such storage devices include non-volatile memory devices.

As described above, IPU chip 200 includes four LP DDR5 blocks 240 that implement respective LP DDR5 memory channels. For simplicity, the physical interconnects from the memory channel interfaces on IPU chip 200 and memory devices 1116 is collectively shown as an interconnect structure 1122. Those who have skill in the art will understand there would be separate physical interconnect structures to implement each LP DDR5 memory channel.

IPU chip 200 is also connected to PCIe edge connectors via an x32 PCIe link 1124. This connection is shown at the bottom of IPU chip 200, while in practice the x32 PCIe link would be connected to PCIe interface 202.

FIG. 11a shows an augmented version of FIG. 11 now further including details of packet processing pipeline 222 and lookaside cryptographic and compression engine 244 illustrated in FIG. 2a and discussed above. There atomic thread migrations supported by the embodiments herein include thread migrations within a given chip such as an IPU, DPU, or SmartNIC chip, and between chips. Moreover, the term “fabric” has used herein including the claims comprises the various interconnects and associated protocols that are implemented within chips or packages such as IPUs, DPUs, and SmartNICs and the interconnects/links between chips.

Generally, to support thread migration to a target the pipeline will expose a small, well-defined execution environment (e.g., an “ACRE worker slot”). For example, for lookaside cryptographic and compression engine 244 an ACRE worker slot could be implemented as part of work queue manager 268 or could be implemented in LCE interface 266. For packet processing pipeline 222 a block (not shown) could be added to implement an ACRE worker slot.

FIG. 11b shows an IPU 1100b that is a variant of IPU 1100 further including an FPGA 1126 and memory devices 1128. FPGA 1126 is communicatively coupled to IPU chip 200 via a fabric link 1130 coupled between a port on PCIe interface 202 and a PCIe port on FPGA 1126. Optionally, FPGA 1126 may be communicatively coupled to CPU/SoC 1108 via a fabric link 1132. Under IPU 1100b, XPU 1110 is another type of XPU other than an FPGA, and may include any of the XPUs disclosed herein.

Programmed logic in FPGA 1126 and/or execution of software on CPU/SoC 1108 may be used to implement various IPU functions. FPGA 1126 may include logic that is pre-programmed (e.g., by a manufacturer) and/or logic that is programmed in the field. For example, logic in FPGA 1126 may be programmed by a host CPU for a platform in which IPU 1100b is installed. FPGA 1126 may also be programmed using code executing on CPU/SoC 1108 or a core 236 in IPU chip 200.

CPU/SoC 1108 employs a System on a Chip including multiple processor cores. Various CPU/processor architectures may be used, including but not limited to x86 and ARM® architectures. In one non-limiting example, CPU/SoC 1108 comprises an Intel® Xeon® processor. Software executed on the processor cores may be loaded into memory 1112, either from a storage device (not shown), from a host, or received over a network coupled to optical module 1104 and 1106.

Generally, under SmartNIC embodiments, a SmartNIC chip may be used in place of the IPU chip shown in the embodiments of FIGS. 11, 11a, and 11b. Similarly, under DPU embodiments, a DPU chip may be used in place of the IPU chip shown in the embodiments of FIGS. 11, 11a, and 11b.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory, JESD235B, originally published in December 2018, HBM2 (HBM version 2, JESD235D, originally published in March 2021, HBM3 (HBM version 3, JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Tri-Level Cell (“TLC”), Quad-Level Cell (“QLC”), Penta-Level Cell (PLC) or some other NAND). A NVM device can also include a byte-addressable write-in-place three dimensional crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

The terminology “engine” is used herein. Generally, the engines described and illustrated herein represent hardware-based components configured to perform the functionality associated with a given engine. Engines may be implemented using embedded hardware or embedded logic, such as but not limited to intellectual property (IP) blocks, ASICs, and code executing on embedded processor elements and the like.

As used herein, the terminology “processing element” and “compute element” refers to any type of component that performs a processing or computing function, including but not limited to processor cores, processing pipeline components, microcontrollers, and various types of embedded processors.

The following examples pertain to additional examples of the teachings and principles disclosed herein.

Example 1. An apparatus is provided comprising a plurality of compute elements interconnected via a fabric and one or more hardware engines. The apparatus is configured to execute a thread on a first compute element and to capture an architectural state of the thread as a snapshot. The apparatus is further configured to stream a migration packet over the fabric containing the snapshot to a target that includes a second compute element. At the target, a hardware engine restores the architectural state of the thread. The apparatus resumes execution of the thread on the second compute element.

Example 2. The apparatus of example 1 is configured such that at least a portion of the plurality of compute elements are integrated on an Infrastructure Processing Unit (IPU) chip, a Data Processing Unit (DPU) chip, or a Smart Network Interface Controller (SmartNIC) chip.

Example 3. The apparatus of example 2 is configured so that the target is implemented on the IPU chip, the DPU chip, or the SmartNIC chip.

Example 4. The apparatus of any of the preceding claims is arranged so that a first portion of the plurality of compute elements are integrated on a first chip or die and a second portion of the plurality of compute elements are integrated on a second chip or die coupled to the first chip or die via one or more fabric links. In this arrangement, the first compute element is among the first portion of the plurality of compute elements and the second compute element is among the second portion of the plurality of compute elements.

Example 5. The apparatus of any of the preceding claims is configured where the first compute element is a core on a Central Processing Unit (CPU), an IPU chip, a DPU chip, or a SmartNIC chip. The apparatus further defines the second compute element as a compute element on an other processing unit (XPU) comprising a Graphic Processing Unit (GPU) or General Purpose GPU (GP-GPU), a Tensor Processing Unit (TPU), an Artificial Intelligence (AI) processor or AI inference unit, or an FPGA (Field Programmable Gate Array).

Example 6. The apparatus of example 5 is implemented when the XPU comprises a GPU or FPGA.

Example 7. The apparatus of any of the preceding claims is configured so that the architectural state of the thread includes register states. The hardware engine at the target is configured to atomically restore registers with the register states.

Example 8. The apparatus of example 7 is further configured so that the hardware engine at the target issues targeted cache/TLB (translation lookaside buffer) coordination hints.

Example 9. The apparatus of any of the preceding claims is further configured to implement a priority scheme under which transfer of migration packets used for thread migration is prioritized over other traffic on the fabric.

Example 10. The apparatus of any of the preceding claims is configured so that the target comprises a packet processing pipeline, a cryptography pipeline, a compression pipeline, or a decompression pipeline.

Example 11. A method for migrating a thread on a platform comprising a plurality of compute elements interconnected via a fabric includes capturing an architectural state of a thread executing on a first compute element as a snapshot. The method further includes streaming a migration packet over the fabric containing the snapshot to a target that includes a second compute element. The method restores, via a hardware engine at the target, the architectural state of the thread. The method concludes by resuming execution of the thread on the second compute element.

Example 12. The method of example 11 is carried out wherein the thread is migrated from a core on a Central Processing Unit (CPU) comprising the first compute element to a compute element on a SmartNIC or Infrastructure Processing Unit (IPU) chip.

Example 13. The method of example 11 or 12 is carried out wherein the thread is migrated from a first compute element on a SmartNIC or IPU chip or die to a second compute element on an other processing unit (XPU) chip or die. The migration occurs over a fabric link coupling the SmartNIC or IPU chip or die to the XPU chip or die.

Example 14. The method of any of examples 11-13 is performed where the target comprises a packet processing pipeline, a cryptography pipeline, a compression pipeline, or a decompression pipeline.

Example 15. The method of any of examples 11-14 is performed such that the migration of the thread is completed in less than 1 microsecond.

Example 16. An apparatus is provided comprising a System on a Chip (SoC) or System on Package (SoP) having a plurality of components integrated thereon. The apparatus includes a plurality of compute cores and respective sets of processing elements configured to implement one or more respective processing pipelines. A fabric interconnects the compute cores to processing elements in the one or more processing pipelines. The apparatus is configured to perform an atomic migration of a thread executing on a compute core to a processing element in a target. The apparatus is further configured to resume execution of the thread on the processing element in the target.

Example 17. The apparatus of example 16 further comprises one or more capture engines and one or more restore engines. The apparatus is configured to capture a snapshot of an architecture state of a thread executing on the compute core with a capture engine, the snapshot including register states. The apparatus sends a migration packet containing the snapshot over the fabric to a processing element in the target. A restore engine atomically restores registers for the processing element with the register states in the snapshot.

Example 18. The apparatus of example 17 is further configured to implement a priority scheme under which transfer of migration packets used for thread migration is prioritized over other traffic on the fabric.

Example 19. The apparatus of any of examples 16-18 is realized where the apparatus comprises an Infrastructure Processing Unit, a Data Processing Unit, or a Smart Network Interface Controller (SmartNIC) chip.

Example 20. The apparatus of any of examples 16-19 is configured so that the target comprises a packet processing pipeline, a cryptography pipeline, a compression pipeline, or a decompression pipeline.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The operations and functions performed by various components described herein may be implemented by software running on a processing element, compute element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus, comprising:
a plurality of compute elements interconnected via a fabric; and
one or more hardware engines;
wherein the apparatus is configured to,
execute a thread on a first compute element;
capture an architectural state of the thread as a snapshot;
stream a migration packet over the fabric containing the snapshot to a target including a second compute element;
restore, via a hardware engine at the target, the architectural state of the thread; and
resume execution of the thread on the second compute element.

2. The apparatus of claim 1, wherein at least a portion of the plurality of compute elements are integrated on an infrastructure processing unit (IPU) chip, a data processing unit (DPU) chip or a Smart Network Interface Controller (SmartNIC) chip.

3. The apparatus of claim 2, wherein the target is implemented on the IPU chip, the DPU chip, or the SmartNIC chip.

4. The apparatus of claim 1, wherein a first portion of the plurality of compute elements are integrated on a first chip or die, a second portion of the plurality of compute elements are integrated on a second chip or die coupled to the first chip or die via one or more fabric links, and wherein the first compute element is among the first portion of the plurality of compute elements and the second compute element is among the second portion of the plurality of compute elements.

5. The apparatus of claim 1, wherein the first compute element is a core on a central processing unit (CPU), an infrastructure processing unit (IPU) chip, a data processing unit (DPU) chip, or a Smart Network Interface Controller (SmartNIC) chip and wherein the second compute element is a compute element on an other processing unit (XPU) comprising a Graphic Processing Unit (GPU) or General Purpose GPU (GP-GPU), a Tensor Processing Unit (TPU), an Artificial Intelligence (AI) processor or AI inference unit, or an FPGA (Field Programmable Gate Array).

6. The apparatus of claim 5, when the XPU comprises a GPU or FPGA.

7. The apparatus of claim 1, wherein the architectural state of the thread includes register states, and the hardware engine at the target is configured to atomically restore registers with the register states.

8. The apparatus of claim 7, wherein the hardware engine at the target is configured to issue targeted cache/TLB (translation lookaside buffer) coordination hints.

9. The apparatus of claim 1, wherein the apparatus is further configured to implement a priority scheme under which transfer of migration packets used for thread migration is prioritized over other traffic on the fabric.

10. The apparatus of claim 1, wherein the target comprises a packet processing pipeline, a cryptography pipeline, a compression pipeline, or a decompression pipeline.

11. A method for migrating a thread on a platform comprising a plurality of compute elements interconnected via a fabric, comprising:
capturing an architectural state of a thread executing on a first compute element as a snapshot;
streaming a migration packet over the fabric containing the snapshot to a target including a second compute element;
restoring, via a hardware engine at the target, the architectural state of the thread; and
resuming execution of the thread on the second compute element.

12. The method of claim 11, wherein the thread is migrated from a core on a Central Processing Unit (CPU) comprising the first compute element to a compute element on a SmartNIC or Infrastructure Processing Unit (IPU) chip.

13. The method of claim 11, wherein the thread is migrated from a first compute element on a Smart Network Interface Controller (SmartNIC) or Infrastructure Processing Unit (IPU) chip or die to a second compute element on an other processing unit (XPU) chip or die over a fabric link coupling the SmartNIC or IPU chip or die to the XPU chip or die.

14. The method of claim 11, wherein the target comprises a packet processing pipeline, a cryptography pipeline, a compression pipeline, or a decompression pipeline.

15. The method of claim 11, wherein the migration of the thread is performed in less than 1 microsecond.

16. An apparatus comprising a System on a Chip (SoC) or System on Package (SoP) having a plurality of components integrated thereon including:
a plurality of compute cores;
respective sets of processing elements configured to implement one or more respective processing pipelines;
a fabric interconnecting compute cores to processing elements in the one or more processing pipelines;
wherein the apparatus is configured to perform an atomic migration of a thread executing on a compute core to a processing element in a target; and
resume execution of the thread on the processing element in the target.

17. The apparatus of claim 16, further comprising:
one or more capture engines; and
one or more restore engines,
wherein the apparatus is configured to,
capture a snapshot of an architecture state of a thread executing on the compute core with a capture engine, the snapshot including register states;
send a migration packet containing the snapshot over the fabric to a processing element in the target; and
atomically restore registers for the processing element with the register states in the snapshot with a restore engine.

18. The apparatus of claim 17, wherein the apparatus is further configured to implement a priority scheme under which transfer of migration packets used for thread migration is prioritized over other traffic on the fabric.

19. The apparatus of claim 16, wherein the apparatus comprises an Infrastructure Processing Unit, a Data Processing Unit, or a Smart Network Interface Controller (SmartNIC) chip.

20. The apparatus of claim 16, wherein the target comprises a packet processing pipeline, a cryptography pipeline, a compression pipeline, or a decompression pipeline.
